(19) United States
(12) Patent Application Publication
(10) Pub. No.: US 2017/0066919 A1
(43) Pub. Date: Mar. 9, 2017

(54) RESIN DISPERSION

(71) Applicant: Hexion Inc., Columbus, OH (US)

(72) Inventors: Gunda KUHLMANN, Hamm (DE); Andreas BLÖTZ, Iserlohn (DE); Carsten ROMAHN, Iserlohn (DE); Michael SCHWAB, Iserlohn (DE)

(21) Appl. No.: 15/356,205

(22) Filed: Nov. 18, 2016

Related U.S. Application Data
(62) Division of application No. 12/599,011, filed on Jan. 11, 2010, now abandoned.

(30) Foreign Application Priority Data
Jun. 25, 2007 (DE) 102007029531.8

(51) Int. Cl. C08L 63/00

(52) U.S. Cl. CPC C08L 63/00; C08L 2201/54; C08L 2205/03

(57) ABSTRACT

Disclosed is a resin dispersion, a method for production thereof and a product. According to the invention, a resin dispersion may b prepared, during the processing of which the release of polluting materials may be avoided, wherein the resin dispersion contains (I) 30 to 100 wt. % epoxide resin, 0-70 wt. % Novolak resin based on the mass of both resin components, (II) 4 to 18 wt. %, based on the total weight, of a co-dispersing agent made from ricin oil ethoxylate, hydrated ricin oil ethoxylate, alkylphenol ethoxylate, fatty alcohol ethoxylate, oleic acid ethoxylate, oxoalcohol ethoxylate, fatty alcohol alkoxylate and/or polyvinyl alcohol and (III), optionally, 0 to 20 wt. %, based on the total mass, of further conventional adjuncts.

### RELATED APPLICATION DATA

This application is a divisional application of co-pending U.S. application Ser. No. 12/599,011 with a filing date of Jan. 11, 2010, which application claims the benefit of PCT Application PCT/EP2008/005033 with International Filing Date of Jun. 23, 2008, published as WO 2009/000483 A1, which further claims priority to German Patent Application No. 102007029531.8 filed Jun. 25, 2007, the entire contents of all applications are hereby incorporated by reference.

### FIELD OF THE INVENTION

This invention relates to a resin dispersion, to a process for producing it and to a product.

The production of impregnations of building construction products utilizes resin dispersions which have generally consisted of aqueous resols or acrylate dispersions. Dispersions based on resols are thinnable with water, but eliminate formaldehyde on curing and hence fabrication can only be carried out in plant specifically designed for that purpose. Acrylate dispersions can be cured without emission of environmentally harmful substances, but the cured products have a low glass transition temperature.

Dispersions based on epoxy resins and novolaks are known from the prior art. JP 58-027716 describes a process for producing a phenolic resin/novolak dispersion and an amine (particularly imidazole) as curative for an epoxy resin. US RE37,023 discloses a dispersion of resol and an etherified BPA resin wherein solvent is also used.

It is an object of the present invention to provide resin dispersions whose processing avoids the release of environmentally burdensome materials.

### SUMMARY OF THE INVENTION

We have found that this object is achieved according to the present invention by providing an aqueous resin dispersion based on epoxy resins and novolak resins and also further added substances, wherein the resin dispersion contains:
(I) 30 to 100 weight percent of epoxy resin and 0-70 weight percent of novolak resin based on the mass of both resin components and also
(II) 4 to 18 weight percent based on the overall mass of a codispersant based on castor oil ethoxylate, hydrogenated castor oil ethoxylate, alkylphenol ethoxylate, fatty alcohol ethoxylate, oleic acid ethoxylate, oxo process alcohol ethoxylate, fatty alcohol alkoxylate and/or polyvinyl alcohol and
(III) optionally 0 to 20 weight percent based on the overall mass of further customary added substances.

### DETAILED DESCRIPTION

The epoxy resin of constituent (I) can be any epoxy resin having at least two epoxy groups per molecule and the melting range of which is preferably below 90° C. When epoxy resins having a higher melting range are used, there may be technical difficulties owing to the increased viscosity of the epoxy resin used. Preference is given in turn to epoxy compounds that are liquid at room temperature, such as diglycidyl ethers of bisphenols or advanced resins based on bisphenol A diglycidyl ethers. Of special preference are low viscosity resins such as epoxy resins based on cycloolefins or tetra-glycidyl-dianiline or else mixtures of solid epoxy resins such as, for example, epoxidized novolaks with so-called reactive diluents. The epoxy resins may optionally be modified with other polymers such as, for example, polyesters, acrylates, silicone polymers or polyvinyl derivatives.

The novolak of constituent (I) comprises copolymers of a phenolic compound and an aldehyde that are prepared in an acidic medium using a ratio of phenolic compound:aldehyde which is preferably in the range from 1:0.4 to 1:0.8. These copolymers can be prepared to be free of monomer. In the case of a ratio greater than 1:0.8, the resulting novolak is too viscous and in the case of a ratio of less than 1:0.4 the resins are too water-soluble and therefore more difficult to disperse.

As phenolic compounds there may be used mono- or polynuclear phenols or mixtures of the class of compounds mentioned, specifically both mono- and polynuclear phenols. Examples thereof are phenol itself as a preferred variant, and also its alkyl-substituted homologs, such as o-, m- or p-cresol, xylenes or more highly alkylated phenols, also halogen-substituted phenols, such as chlorophenol and bromophenol, and polyfunctional phenols such as resorcinol or pyrocatechol, and also polynuclear phenols such as naphthols, bisphenol A or bisphenol F.

Phenol, or the phenolic component, is reacted with aldehyde, in particular formaldehyde or a formaldehyde-yielding compound, to form the desired novolak. The novolaks may be modified with customary modifying agents, for example epoxy resins, rubbers, polyvinyl butyral and inorganic additives.

The amount of epoxy resin is 30 to 100 weight percent and the amount of novolak is 70 to 0 weight percent based on the mass of both resin components. The production of a purely epoxy resin dispersion has the advantage that it can be provided as needed for blending with other dispersions. However, preference is given to resin dispersions comprising 30 to 80 weight percent of epoxy resin, since the novolak acts as a curative for the epoxy resin and therefore no additional curative is needed. Preference is again given to 50 to 80 percent by weight of epoxy resin, whereby an optimum of network density is achieved.

The further constituent (II) of the aqueous resin dispersion of the present invention comprises 4 to 18, preferably 3 to 10, weight percent based on the overall mass, of a codispersant based on castor oil ethoxylate, hydrogenated castor oil ethoxylate, alkylphenol ethoxylate, fatty alcohol ethoxylate, oleic acid ethoxylate, oxo process alcohol ethoxylate, fatty alcohol alkoxylate and/or polyvinyl alcohol. Less than 4% by weight of codispersant does not provide an adequate effect, and more than 18% by weight of codispersant has an adverse effect on the final properties, for example the water solubility, of the cured product.

It is particularly preferred to use polyvinyl alcohol, which acts as a protective colloid as well as an emulsifier. It is in turn preferable for polyvinyl alcohol to have a degree of hydrolysis in the range from 80 to 95% and a molecular weight in the range from 30 000 to 70 000 g/mol, because this has a beneficial effect on the stability of the emulsion.

The resin dispersion of the present invention may further comprise at least a stabilizer—preferably in a concentration of 0.2% to 2% by weight, based on the mass of the overall mixture—based on high molecular weight alcohols or else cellulose derivatives, starch, dextrin, polyacrylic acid and/or copolymeric salts thereof; poly-N-vinylmethylacetamide, vinylpyrrolidone copolymers and/or Stimme protective colloids. The stability of the dispersion is enhanced in this way. It is particularly preferable when the stabilizer is methoxycellulose, since this stabilizer is effective at very low concentrations.

The resin dispersion of the present invention may also include further constituents such as substances which accelerate the curing reaction, for example Lewis acids or imidazoles in an amount of 0% to 1.5% by weight, based on the mass of the entire mixture. Of advantage are in turn imidazoles which, as well as the accelerating effect, also endow the accelerated dispersion with a high stability of several hours to days.

The resin dispersion of the present invention may further include processing assistants in a concentration, preferably, of 0.05% to 3% by weight, based on the mass of the entire mixture, such as flow agents to improve filming, or else substances to fine-tune specific properties such as, for example, acrylate dispersions to enhance the flexibility. The use of ethylene glycol and/or polydimethylsiloxane may be mentioned by way of example. Similarly, the addition of dyes, wetting agents and catalysts as further added substances is conceivable.

The resin dispersion of the present invention preferably has a solids content of 30-50%. However, depending on the planned application, lower solids concentrations (about 10%) are also possible.

The resin dispersion of the present invention, which is based on epoxy resins and novolak resins and also further added substances, is obtainable by a process comprising the following steps:
a. admixing at least the codispersant to the constituent (I) present essentially in the melt, and
b. admixing water and optionally further added substances at temperatures <100° C. to the mixture obtained in step a).

The temperature at which the constituent (I) is melted is preferably between 90 and 150° C., preferably up to 125° C., in order that premature reaction of the components may be safely ruled out. This temperature range is also beneficial for viscosity reasons in order that a homogeneous mixture of constituent (I) may be achieved. The codispersant is added and the mixture is cooled to <100° C. This is followed by the addition of water, preferably at 25%-50% based on the overall mass. Further water is added as appropriate with stirring and cooling. The resin solids content is preferably 30% to 50%.

It is generally immaterial in which order and at which temperature the codispersant and the constituent (I) and water are mixed with the other added substances.

It is particularly preferable when the stabilizer is added in step b), since this makes it possible to use thermally sensitive stabilizers.

It is further of advantage when obtaining the mixture in step b) the resin dispersion is admixed with still further added substances such as catalysts, dyes and wetting agents.

However, it is also possible for the aqueous resin dispersion of the present invention, which is based on epoxy resins and novolak resins and also further added substances, to be produced by mixing the constituents (I), (II) and (III) of the resin dispersion and water together by introducing shearing energy. This makes it possible to dispense with heating of the constituents and avoid the associated problems with regard to handling.

For this process, carried out in dispersion mills or turbine internal mixers for example, water is initially charged and the codispersant and, as the case may be, further substances are added. While stirring, the epoxy resin and the novolak are then added and shearing energy is introduced to a sufficient degree.

The uncrosslinked aqueous resin dispersion of the present invention can be applied to textile, mineral, metallic or else polymeric surfaces in the form of fibers, fibrous nonwoven webs, wovens, wools or smooth surfaces in a straightforward and uncomplicated manner, for example by brushing, spraying or blade coating, to modify these substrates. Drying operations may follow. During and also after crosslinking, no formaldehyde or any other solvent is released, which would be an environmental or more specifically odor nuisance. The applications served by water-soluble resols and acrylates can now be covered by the resin dispersion of the present invention.

### EXAMPLE

The invention will now be more particularly described with reference to an illustrative embodiment:

In a 21 flask equipped with stirrer, thermometer, dropping funnel and heating jacket, 120 g of novolak and 280 g of epoxy resin are heated to about 110° C. during 60 min. 290 g of a 23.5 percent strength solution of polyvinyl alcohol in water are then added during 30 minutes with stirring. The temperature is maintained at about 75-85° C. in the course of the addition. Then, 310 g of water are metered in during 90 min at about 75-85° C. with stirring. The dispersion formed is gradually cooled down to about 40° C. The dispersion has a viscosity of 5080 mPas at 20° C. and a solids content of about 47.6%.

We claim:

1. A process for producing the aqueous resin dispersion based on epoxy resins and novolak resins, and also optionally further added substances, comprising:
a. admixing at least the codispersant to the 30 to 100 weight percent of epoxy resin and 0-70 weight percent of novolak resin based on the mass of both resin components, present essentially in the melt, and
b. admixing water and optionally further added substances at temperatures <100° C. to the mixture obtained in step a).

2. The process of claim 1 wherein a stabilizer is added as added substance in step b).

3. The process of claim 1 wherein after obtaining the mixture in step b) the resin dispersion is admixed with one or more further added substances consisting of catalysts, dyes, wetting agents, or combinations thereof

4. Process for producing an aqueous resin dispersion based on epoxy resins and novolak resins and also optionally further added substances, comprising mixed together by introducing shearing energy a composition comprising:
(I) 30 to 100 weight percent of epoxy resin and 0-70 weight percent of novolak resin based on the mass of both resin components and also
(II) 4 to 18 weight percent based on the overall mass of a codispersant based on castor oil ethoxylate, hydrogenated castor oil ethoxylate, alkylphenol ethoxylate, fatty alcohol ethoxylate, oleic acid ethoxylate, oxo process alcohol ethoxylate, fatty alcohol alkoxylate and/or polyvinyl alcohol, and
(III) optionally 0 to 20 weight percent based on the overall mass of further customary added substances, and
water.

5. The process of claim 1 wherein the optionally further added substances are consisting of stabilizer, catalysts, dyes, wetting agents, or combinations thereof.

6. A product having a crosslinked or uncrosslinked surficial layer produced by applying the resin dispersion according to claim 1.

7. The use of the aqueous resin dispersion of claim 1 for modifying textile, mineral, metallic or polymeric surfaces in the form of fibers, fibrous nonwoven webs, wovens, wools or smooth surfaces.
